(19) United States
(12) Patent Application Publication
(10) Pub. No.: US 2023/0331936 A1
(43) Pub. Date: Oct. 19, 2023

(54) HYDROGEL PREPARATION METHOD USING CROSSLINKING STRUCTURE CONTROL BY ELECTRON BEAM IRRADIATION AND NATURAL POLYSACCHARIDE HYDROGEL PREPARED BY THE SAME

(71) Applicants: GEV Co., Ltd., Maengdong-myeon (KR); BIOCOS INC., Hanam-si (KR)

(72) Inventors: Tae-Sung HA, Deoksan-eup (KR); Pyeong-Hwan JUNG, Deoksan-eup (KR); Young-Ah KIM, Daejeon (KR); Yeon-Hee KIM, Seoul (KR); Ji-Hyun PARK, Sejong-si (KR); Yu-Ji KANG, Hanam-si (KR)

(73) Assignees: BIOCOS INC., Hanam-si (KR); GEV Co., Ltd., Maengdong-myeon (KR)

(21) Appl. No.: 18/134,107

(22) Filed: Apr. 13, 2023

(30) Foreign Application Priority Data
Apr. 14, 2022 (KR) 10-2022-0046380

(51) Int. Cl. C08J 3/075; C08J 3/24; C08J 3/28

(52) U.S. Cl. CPC C08J 3/075; C08J 3/246; C08J 3/28; C08J 2305/00; C08J 2405/00

(57) ABSTRACT

Disclosed is a hydrogel preparation method using crosslinking structure control by electron beam irradiation and a hydrogel prepared by the same, and the hydrogel preparation method includes: (A) mixing two or more natural polysaccharides and a solvent at room temperature to prepare a preliminary hydrogel composition; (B) heating the preliminary hydrogel composition to a predetermined temperature or higher to cause the preliminary hydrogel composition to be loosened linearly with respect to a chain-coil structure of the natural polysaccharides, resulting in uniform mixing; (C) lowering the temperature of the preliminary hydrogel composition to room temperature to gel the preliminary hydrogel composition into a hydrogel, and allowing the two or more natural polysaccharides to form a mesh structure by chain entanglement to form an Interpenetrating Polymer Network (IPN) structure; and (D) selectively irradiating the hydrogel with a high-energy electron beam to control a crosslinking structure by using chain scission reaction in the IPN structure of the hydrogel. According to the present invention, it is possible to prepare a hydrogel composed of only two or more kinds of natural polysaccharides, and increase functionality, such as moisturizing effect, while maintaining sufficient physical strength by controlling the crosslinking structure by using a chain scission reaction through high-energy electron beam irradiation, it is possible to use excellent functionality, such as biocompatibility and biodegradability, and in particular, it is possible to adjust a mesh size to provide a natural polysaccharide hydrogel which enables the moisture or active substance entrapped in the natural polysaccharides to escape to the outside and be well delivered to the desired area.

### CROSS-REFERENCE TO RELATED APPLICATIONS

This application claims priority to and the benefit of Korean Patent Application No. 10-2022-0046380 filed in the Korean Intellectual Property Office on Apr. 14, 2022, the entire contents of which are incorporated herein by reference.

### TECHNICAL FIELD

The present invention relates to a hydrogel preparation method using crosslinking structure control by electron beam irradiation and a natural polysaccharide hydrogel prepared by the same, and more particularly, a hydrogel preparation method using crosslinking structure control by electron beam irradiation, in which a hydrogel composed of two or more kinds of only natural polysaccharides is prepared, and a crosslinking structure is controlled by the emission of high-energy electron beams to the hydrogel and chain scission reactions to increase functionalities, such as moisturizing effects, while maintaining sufficient physical strength, and a natural polysaccharide hydrogel prepared by the same.

### BACKGROUND ART

In general, a hydrogel means a material with a three-dimensional, hydrophilic polymeric reticular structure that can contain large amounts of water.

The hydrogel is capable of absorbing at least 20% of water by total weight, and a hydrogel that absorbs more than 95% of water is called a superabsorbent hydrogel.

The hydrogels may be broadly categorized into two types: a physical hydrogel and a chemical hydrogel, and a physical hydrogel has non-permanent properties because the chain structure is connected by electrostatic forces, hydrogen bonding, hydrophobic reactions, and chain entanglement, and the physical hydrogel is changed into a solution when heated, and a chemical hydrogel has permanent properties because covalent bonding are made between chains by chemical crosslinking or irradiation crosslinking.

An example of one type of the hydrogel is a polysaccharide hydrogel based on polysaccharides, which are carbohydrate molecules with a long chain structure composed of glycoside bonding and are polymers of natural origin, and the polysaccharide-based hydrogels have very good biocompatibility and biodegradability and are therefore widely used in the medical and pharmaceutical fields, including bio-fields.

Typical materials for the polysaccharide hydrogels are natural polysaccharides, such as alginate, chitosan, carrageenan, agar, and locust bean gum.

However, despite the fact that natural polysaccharides have the foregoing functionalities of biocompatibility and biodegradability, there are significant difficulties in preparing natural polysaccharides into hydrogels only with the technology using only natural polysaccharides due to limitations in reactivity and processability.

To solve this problem, the Interpenetrating Polymer Network (IPN) method is used, and the IPN means a polymer in which two or more networks are formed by chain entanglement rather than covalent bonding.

IPN hydrogels, which incorporate the IPN, have excellent mechanical properties, such as tensile strength and elongation, but the mesh size of the network structure is very small and the mesh forms a dense structure, so there is the disadvantage of not allowing enough water or active substances trapped between the meshes to escape, and as a result, there is a problem in that the effect of delivering various functional substances to the desired area including the moisturizing effect was poor.

To solve the problem, in the related art, as a method of increasing the mesh size of the IPN hydrogel to facilitate the release of substances, a method of introducing a porogen to a synthesis process of the hydrogel is grafted.

However, the method in the related art of introducing a porogen to the hydrogel synthesis process requires a complex and difficult process to remove the introduced porogen after the hydrogel is synthesized, and in particular, there was a problem and inconvenience of separately selecting and preparing a porogen that can make the mesh size of the hydrogel uniform.

On the other hand, in the prior art literature, Korean Patent No. 10-1848272 discloses a hydrogel having a semi-IPN structure by mixing polyvinyl alcohol with alginate and cationic crosslinker, and the synthesized hydrogel is an atypical form with a viscosity of 3000 cP, and cationic crosslinkers (Ca2+, Mg2+, and the like) are used for crosslinking and structural adjustment, so that there is a technical difference.

In addition, Korean Patent No. 10-2005-0113427 discloses an IPN hydrogel made of polyvinyl alcohol and poly N-isopropylacrylamide as the main components and a method of preparing the same, and there are technical differences, such as not using human-friendly natural polysaccharides.

In addition, the Korean Patent No. 10-1929293 relates to a method of manufacturing IPN hydrogel beads composed of alginate and cellulose, which are natural polysaccharides, and presents a method of crosslinking using cationic crosslinking agents (Ca²⁺ and Ag³⁺), which has technical differences.

In addition, Korean Patent No. 10-1863955 presents a method of uniformly adjusting the size of the holes in nanofibers to the desired size by using reverse micelles as porogens, which has technical differences.

In addition, Korean Patent No. 10-1272484 presents a method of preparing a hydrogel by mixing collagen, which is a natural polymer, with a number of synthetic polymers and irradiating the mixture with irradiation, in which, however, the irradiation is used only for the crosslinking reaction and synthetic polymers are mixed and used, so that there are technical differences.

### PRIOR ART LITERATURE

[Patent Document]
(Patent Document 1) Korean Patent No. 10-1848272
(Patent Document 2) Korean Patent Application Laid-Open No. 10-2005-0113427
(Patent Document 3) Korean Patent No. 10-1929293
(Patent Document 4) Korean Patent No. 10-1863955
(Patent Document 5) Korean Patent No. 10-1272484

### SUMMARY OF THE INVENTION

The present invention is conceived in response to the background art, and has been made in an effort to provide a hydrogel preparation method using crosslinking structure control by electron beam irradiation, in which a hydrogel composed of two or more kinds of only natural polysaccharides is prepared, and a crosslinking structure is controlled by the emission of high-energy electron beams to the hydrogel and chain scission reactions to increase functionalities, such as moisturizing effects, while maintaining sufficient physical strength, and a natural polysaccharide hydrogel prepared by the same.

The present invention is conceived in response to the background art, and has been made in an effort to provide a hydrogel preparation method using crosslinking structure control by electron beam irradiation, which is capable of preparing a natural polysaccharide hydrogel with excellent biocompatibility and biodegradability without the use of crosslinking agents, and particularly, adjusts a mesh size to help moisture or active substance to be contained in the natural polysaccharide hydrogel and enable the contained moisture or active substance to escape to the outside and be well delivered to the desired area, and a natural polysaccharide hydrogel prepared by the same.

The present invention is conceived in response to the background art, and has been made in an effort to provide a hydrogel preparation method using crosslinking structure control by electron beam irradiation, which utilizes irradiation, but emits high-energy electron beams to simplify a process and reduce preparing costs, and a natural polysaccharide hydrogel prepared by the same.

The present invention is conceived in response to the background art, and has been made in an effort to provide a hydrogel preparation method using crosslinking structure control by electron beam irradiation, which is capable of preparing a hydrogel composed of natural polysaccharides with improved functionality and performing sterilization by irradiation, and a natural polysaccharide hydrogel prepared by the same.

An exemplary embodiment of the present invention provides a hydrogel preparation method using crosslinking structure control by electron beam irradiation, the hydrogel preparation method including: (A) mixing two or more natural polysaccharides and a solvent at room temperature to prepare a preliminary hydrogel composition; (B) heating the preliminary hydrogel composition to a predetermined temperature or higher to cause the preliminary hydrogel composition to be loosened linearly with respect to a chain-coil structure of the natural polysaccharides, resulting in uniform mixing; (C) lowering the temperature of the preliminary hydrogel composition to room temperature to gel the preliminary hydrogel composition into a hydrogel, and allowing the two or more natural polysaccharides to form a mesh structure by chain entanglement to form an Interpenetrating Polymer Network (IPN) structure; and (D) selectively irradiating the hydrogel with a high-energy electron beam to control a crosslinking structure by using chain scission reaction in the IPN structure of the hydrogel.

The natural polysaccharides are two or more kinds selected from alginate, chitosan, carrageenan, agar, guar gum, xanthan gum, gellan gum, and locust bean gum, and at least one of the two or more kinds includes locust bean gum or carrageenan.

The natural polysaccharide is used at a content of 1 to 10 parts by weight with respect to 100 parts by weight of the solvent used.

The solvent is distilled water.

In the operation (B), the preliminary hydrogel composition is heated to 60° C. to 90° C.

In the operation (D), the electron beam is emitted with energy of 1 MeV to 10 MeV and a radiation dose of 5 kGy to 10 kGy.

In the operation (D), an electron beam generated from an electron beam accelerator or radioisotope gamma rays is emitted.

In the operation (D), the scission reaction of chain bonding of the natural polysaccharides is controlled by electron beam irradiation to adjust a mesh size within the IPN structure and maintain interconnectivity between the meshes, to complete a hydrogel with the adjusted mesh size.

In the operations (C) and (D), a mold or a container having a predetermined shape is used to shape the hydrogel.

Another exemplary embodiment of the present invention provides a natural polysaccharide hydrogel prepared by the hydrogel preparation method using crosslinking structure control by electronic beam irradiation.

According to the present invention, it is possible to prepare a hydrogel composed of only two or more kinds of natural polysaccharides, and provide a natural polysaccharide hydrogel capable of increasing functionality, such as moisturizing effect, while maintaining sufficient physical strength by controlling the crosslinking structure by using a chain scission reaction through high-energy electron beam irradiation.

According to the present invention, it is possible to prepare a natural polysaccharide hydrogel having excellent biocompatibility and biodegradability without the use of a crosslinking agent, and in particular, it is possible to adjust a mesh size to provide a natural polysaccharide hydrogel which contains moisture or an active substance and enables the contained moisture or active substance to escape to the outside and be well delivered to the desired area.

According to the present invention, irradiation is utilized, but high-energy electron beams are emitted, so that it is possible to simplify the process and reduce the preparation cost and to prepare a hydrogel composed of natural polysaccharides with increased functionality, and t is possible to sterilize the hydrogel that is vulnerable to contamination through irradiation, providing usefulness that does not require the inclusion of harmful preservatives.

According to the present invention, the present invention is usefully applied and incorporated not only to daily health products, such as mask packs, but also to medical and pharmaceutical fields including the bio field.

### BRIEF DESCRIPTION OF THE DRAWINGS

FIG. 1 is a flowchart illustrating a hydrogel preparation method using crosslinking structure control by electron beam irradiation, according to an exemplary embodiment of the present invention.

FIG. 2 is a process diagram illustrating a hydrogel preparation method using crosslinking structure control by electron beam irradiation according to the exemplary embodiment of the present invention, in which (a) is a diagram illustrating a process of mixing two or more natural polysaccharides, (b) is a diagram illustrating a process of heating an aqueous solution of natural polysaccharides, (c) is a diagram illustrating a process of gelation, (d) is a diagram illustrating a process of emitting electron beams, and (e) is a diagram illustrating a natural polysaccharide hydrogel prepared by controlling a mesh size by electron beam irradiation.

FIG. 3 is a schematic diagram illustrating a crosslinking reaction and a scission reaction according to the electron beam irradiation in the present invention.

FIG. 4 is a schematic diagram illustrating the mechanism of degradation of natural polysaccharide (RH) by electron beam irradiation and a structural diagram illustrating the scission reaction in the hydrogel preparation method using crosslinking structure control by electron beam irradiation according to the exemplary embodiment of the present invention.

FIG. 5 is a photograph of an electron Scanning Electron Microscope (SEM) result showing a 50-times magnification of a cross-section of a sample according to the amount of irradiation in the hydrogel preparation method using crosslinking structure control by electron beam irradiation according to the exemplary embodiment of the present invention.

FIG. 6 is a photograph of an electron Scanning Electron Microscope (SEM) result showing a 1,500-times magnification of a cross-section of a sample according to the amount of irradiation in the hydrogel preparation method using crosslinking structure control by electron beam irradiation according to the exemplary embodiment of the present invention.

FIG. 7 is a diagram showing tensile strength test results of a sample without electron beam irradiation and a sample with crosslinking structure control by electron beam irradiation in the hydrogel preparation method using crosslinking structure control by electron beam irradiation according to the exemplary embodiment of the present invention.

### DETAILED DESCRIPTION

An exemplary embodiment of the present invention will be described with reference to the accompanying drawings, and an object and the configuration, and the features of the present invention will be understood well through the detailed description.

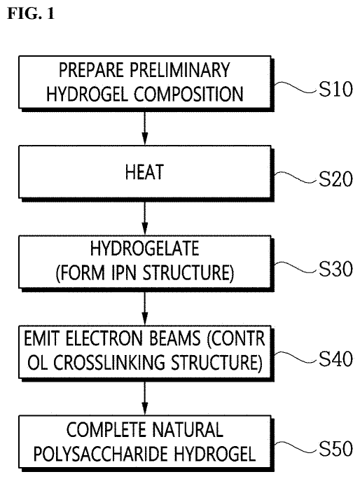

FIGS. 1 to 7 are diagrams for describing a hydrogel preparation method using crosslinking structure control by electron beam irradiation and a natural polysaccharide hydrogel prepared by the same according to an exemplary embodiment of the present invention.

As illustrated in FIG. 1, a hydrogel preparation method using crosslinking structure control by electron beam irradiation according to an exemplary embodiment of the present invention includes a preliminary hydrogel composition preparing operation (S10), a heating operation (S20), a hydrogelation operation (S30), and an electron beam irradiation operation (S40).

The preliminary hydrogel composition preparing operation (S10) is an operation of preparing a preliminary hydrogel composition by mixing two or more kinds of natural polysaccharides and a solvent at room temperature (20° C. to 30° C.).

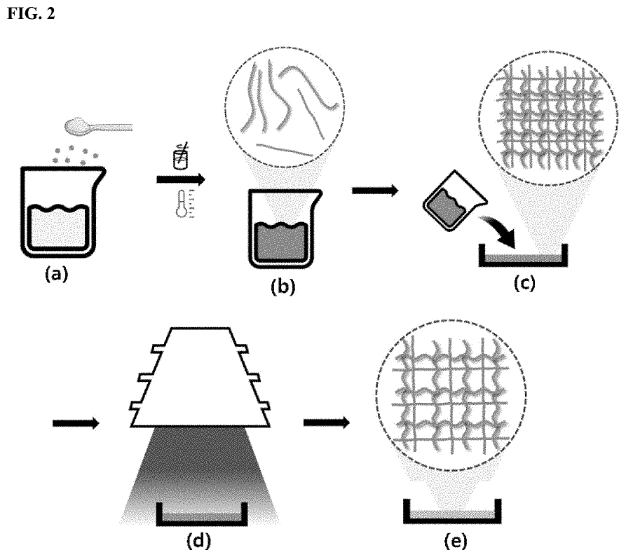

That is, as illustrated in (a) of FIG. 2, the preliminary hydrogel composition preparing operation (S10) is an operation of obtaining a preliminary hydrogel composition having an aqueous solution state by adding two or more natural polysaccharides to a solvent, such as distilled water, and melting the natural polysaccharides and mixing the natural polysaccharides and the solvent.

The natural polysaccharides are materials capable of being gelled, and are two or more kinds selected from alginate, chitosan, carrageenan, agar, guar gum, xanthan gum, gellan gum, and locust bean gum, which have excellent biocompatibility and biodegradability properties.

As the natural polysaccharide, two or more materials are selected from the substances listed above and used, but at least one of the two or more materials selected may preferably be locust bean gum or carrageenan having superior viscosity and strength compared to another natural polysaccharide, and both may be used.

The natural polysaccharide is preferably used at a content of 1 to 10 parts by weight with respect to 100 parts by weight of the solvent used.

The heating operation S20 is an operation of heating the preliminary hydrogel composition in an aqueous solution state prepared through the preliminary hydrogel composition preparation operation S10 to a certain temperature or higher.

That is, as illustrated in (b) of FIG. 2, the heating operation S20 is an operation is an operation in which the natural polysaccharides mixed in the aqueous solution are allowed to be loosened linearly with respect to the chain-coil structure of the natural polysaccharides to be uniformly mixed.

In the heating operation S20, it is preferred to uniformly mix the natural polysaccharides and the aqueous solution by using a homomixer or the like while heating the natural polysaccharides to 60° C. to 90° C., and at room temperature (20° C. to 30° C.), the natural polysaccharides whose chains are aggregated in a coiled form is loosened linearly in the aqueous solution due to the high temperature at which the natural polysaccharides are heated to be changed to a form favorable to occur chain entanglement phenomenon.

Here, when the heating temperature is below 60° C., the natural polysaccharide is not melted in the solvent, and when the heating temperature exceeds 90° C., the evaporation temperature of water approaches 100° C., so the concentration of the natural polysaccharide may change due to solvent evaporation.

The hydrogelation operation S30 is an operation in which the temperature of the preliminary hydrogel composition after the heating operation S20 is lowered to room temperature (20° C. to 30° C.) to gel the preliminary hydrogel composition into a hydrogel.

The hydrogelation operation S30 is an operation in which the two or more natural polysaccharides form a mesh structure by chain entanglement to form an Interpenetrating Polymer Network (IPN) structure as illustrated in (c) of FIG. 2, and gelation is achieved by the IPN structure, which may be referred to as an IPN structure formation operation.

The hydrogelation operation S30 is an operation in which the preliminary hydrogel composition including the two or more kinds of natural polysaccharides linearly elongated and loosened by receiving thermal energy through the heating operation S20 is placed in a mold or container having a desired shape and is gelled into a hydrogel by lowering the temperature to room temperature, and is an operation in which the chains of the natural polysaccharides elongated and loosened in the aqueous solution entangle each other to form the IPN to form a physical gel, and water is trapped within the mesh of the IPN.

The electron beam irradiation operation S40 is an operation in which an electron beam of high energy is appropriately selected, used, and emitted to the hydrogel obtained through the hydrogelation operation S30 to control the crosslinking structure by using a chain scission reaction in the hydrogel side IPN structure.

The electron beam irradiation operation S40, as illustrated in (d) of FIG. 2, is an operation in which the chain bonding scission reaction of the natural polysaccharide in the hydrogel is controlled by electron beam irradiation to adjust the mesh size in the IPN structure and maintain the interconnectivity between the meshes, to complete a hydrogel with a controlled mesh size, and may be referred to as a crosslinking structure control operation.

The electron beam irradiation operation S40 is an operation in which the hydrogel side crosslinking structure is controlled by irradiating the physical hydrogel obtained by using the mold or container with an electron beam, and the glycoside chain bonding of the natural polysaccharide is cut by the electron beam energy, so that the mesh size of the gel becomes larger and the interconnectivity between the meshes becomes slightly looser.

In the above electron beam irradiation operation S40, it is preferable to emit the electron beams with energy of 1 MeV to 10 MeV and a radiation dose of 5 kGy to 10 kGy, which is a very key factor in the present invention to induce a scission reaction for the control of the crosslinking structure.

In this case, electron beams generated in an electron beam accelerator or radioisotope gamma rays may be emitted, and electron beams generated from an electron beam accelerator may be more preferable than gamma rays using radioisotopes.

Here, when the energy of the electron beam is less than 1 MeV, the irradiation energy cannot penetrate the hydrogel uniformly, and when the energy of the electron beam exceeds 10 MeV, there is a risk of irradiation of the irradiated object (hydrogel).

Further, when the radiation dose is less than 5 kGy, there is no significant change in the crosslinking structure of the hydrogel, and when the radiation dose is more than 10 kGy, there is too much scission reaction of the chains of the hydrogel, resulting in weak physical strength.

In general, when the natural polysaccharides are irradiated with the irradiation, the glycoside bonding connecting the main chains are cut, resulting in a sharp drop in physical strength, but the present invention proposes to optimize the scission phenomenon by selecting appropriate energy and radiation dose and to enlarge the crosslinking mesh to facilitate the release of moisture or drugs contained in the mesh, and proposes the crosslinking structure which maintains an appropriate mesh size and interconnectivity between the meshes to stably maintain physical characteristics, such as strength and elongation.

In other words, in the electron beam irradiation operation S40, the energy and the radiation dose of the electron beam are very important factors for controlling the crosslinking structure.

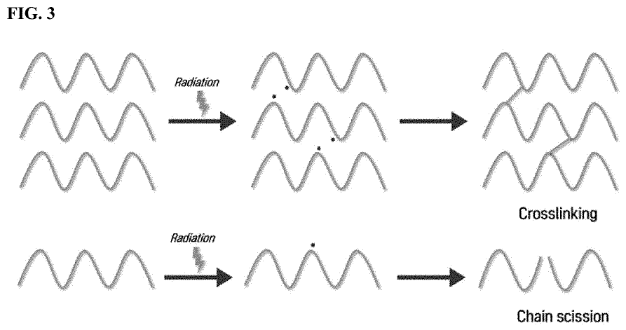

Coincidentally, in irradiation processing, contrasting tendencies, such as crosslinking or chain scission, occur competitively in all irradiated materials, as illustrated in FIG. 3. The competitive relationship between crosslinking (x) and chain scission (s) may be described by the values of the crosslinking rate G(x) and the scission rate G(s), which are given for some synthetic polymers in Table 1 below.

TABLE 1

| polymer | physical state | chemical structure | G(x) | G(y) |
|---|---|---|---|---|
| Polyethylene | Semi-crystalline | 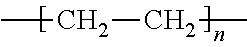 | 0.3 | 0.09 |
| Polypropylene | Semi-crystalline | 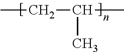 | 0.25 | 0.11 |
| Poly(methyl acrylate) | Amorphous | 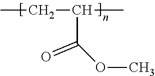 | 0.055 | 0.018 |
| Poly(methyl methacrylate) | Glassy | 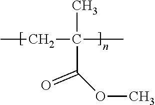 | — | 0.12- 0.35 |
| Poly(vinyl chloride) | Glassy | 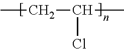 | 0.033 | 0.023 |
| Polystyrene | Glassy | 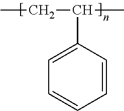 | 0005 | <0.002 |
| Poly(ethylene terephtalate) | Semi-crystalline | 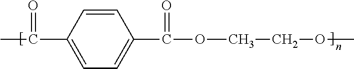 [SMILES: COCCOC(=O)c1ccc(C(C)=O)cc1] | 0.003- 0.02 | 0.007- 0.02 |

As illustrated in Table 1, synthetic polymers are dominated by crosslinking reactions, whereas natural polymers containing polysaccharides are dominated by scission reactions, and the present invention seeks to control the crosslinking structure of the hydrogel side by utilizing the scission reactions.

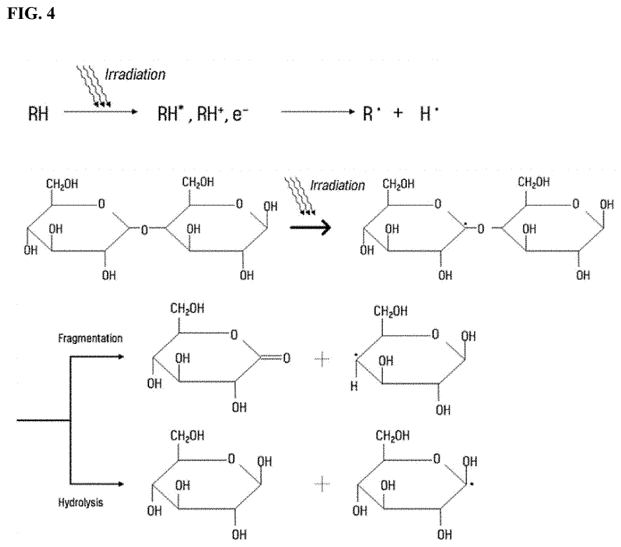

FIG. 4 is a structural diagram of the mechanism of degradation of natural polysaccharides (RH) and the scission reaction by irradiation, and referring to the mechanism diagram in FIG. 4, natural polysaccharides (RH) are changed into radicals in the form of R* and H* through intermediate operations of ionization (RH+, e−) or excitation (RH*) by irradiation.

More specifically, as illustrated in the structural diagram of the scission reaction in FIG. 4, the glycoside chain bonding of the natural polysaccharide is broken by the irradiation and is cut by fragmentation or hydrolysis.

In other words, it is a technical characteristic of the present invention that the crosslinking structure of the hydrogel is controlled by using the scission reaction.

In the meantime, in the following, a natural polysaccharide hydrogel sample with a controlled crosslinking structure was prepared by more specific examples according to the above-described preparation method and comparative examples.

### Example 1

A natural polysaccharide hydrogel sample was prepared by preparing a preliminary hydrogel composition by mixing two kinds of natural polysaccharides, locust bean gum and carrageenan, in distilled water at room temperature, heating the preliminary hydrogel composition to 60° C., pouring the preliminary hydrogel composition into a mold having a predetermined shape, lowering the temperature of the preliminary hydrogel composition to room temperature to gel the preliminary hydrogel composition into a hydrogel, and irradiating the hydrogel with an electron beam with energy of 10 MeV and a radiation dose of 5 kGy to control the crosslinking structure of the hydrogel.

### Example 2

The sample was prepared in the same manner as in Example 1 above, except that the electron beam irradiation was performed with energy of 10 MeV and a radiation dose of 10 kGy.

### Comparative Example 1

The sample was prepared in the same manner as in Example 1 above, but the electron beam irradiation operation was not performed.

### Comparative Example 2

The sample was prepared in the same manner as in Example 1 above, except that the electron beam irradiation was performed with energy of 10 MeV and a radiation dose of 20 kGy.

### Comparative Example 3

The sample was prepared in the same manner as in Example 1 above, except that the electron beam irradiation was performed with energy of 10 MeV and a radiation dose of 40 kGy.

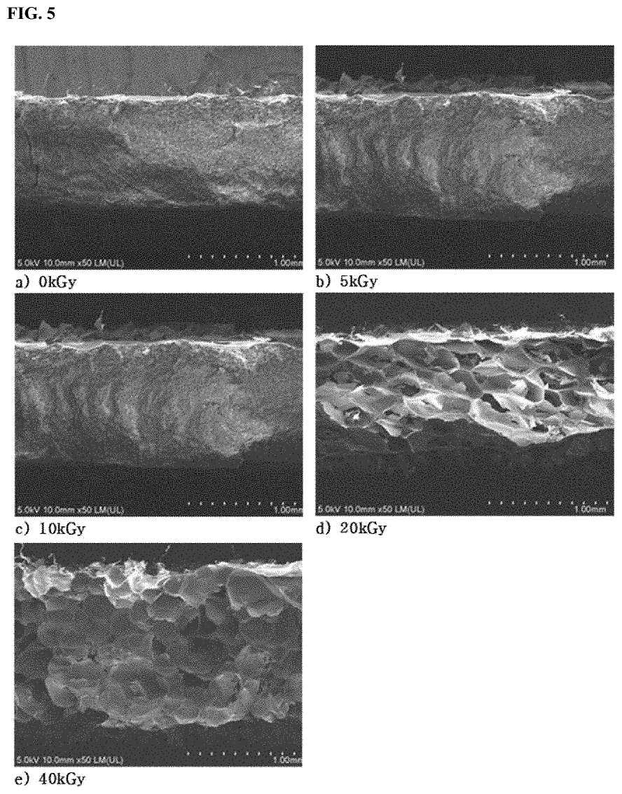

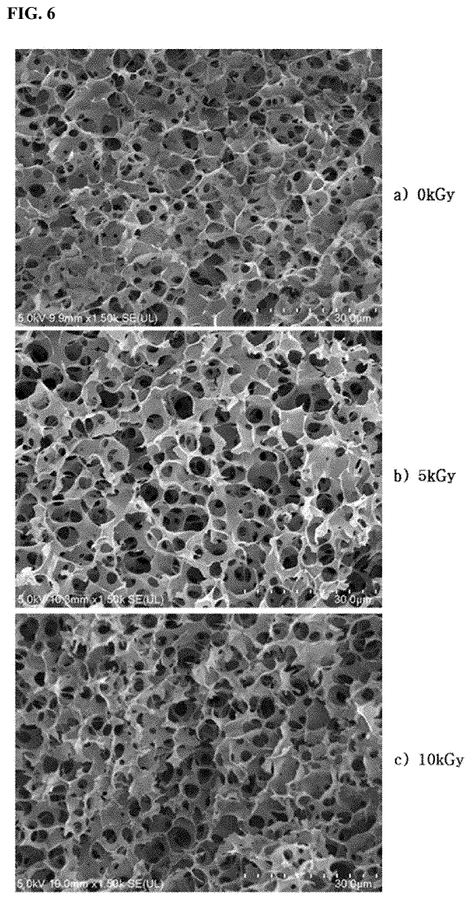

To observe the morphology of the natural polysaccharide hydrogel samples prepared in Examples 1 and 2 and Comparative Examples 1, 2, and 3 at the micro level, 50× and 1500× cross-sectional magnifications were performed by using a Scanning Electron Microscope (SEM), and the results are illustrated in FIGS. 5 and 6.

Investigating the SEM image illustrated in FIG. 5, which shows a 50× magnification image of the sample, the cross-sectional structure of the sample without electron beam irradiation (see a) in FIG. 5) shows no significant change in the structure of the IPN network of the sample, and the cross-sectional structures of the samples irradiated with a radiation dose of 5 kGy (see b) in FIG. 5) and a radiation dose of 10 kGy (see c) in FIG. 5) shows that a change in the IPN network structure of the sample occurs, and it can be seen that when a radiation dose exceeds 20 kGy (see d) and e) in FIG. 5), the IPN network structure of the sample is excessively cut, resulting in excessively increasing the pores and breaking the interconnectivity of the crosslinking structure.

Investigating the SEM images illustrated in FIG. 6, which shows the morphology of the natural polysaccharide hydrogel samples irradiated with radiation doses of 0 kGy, 5 kGy, and 10 kGy, magnified 1500 times for a more accurate observation, the cross-section of each sample irradiated with radiation doses of 5 kGy and 10 kGy (see b) and c) in FIG. 6) shows that compared to the sample a) without radiation, the mesh size is somewhat larger and the interconnectivity between the meshes is maintained.

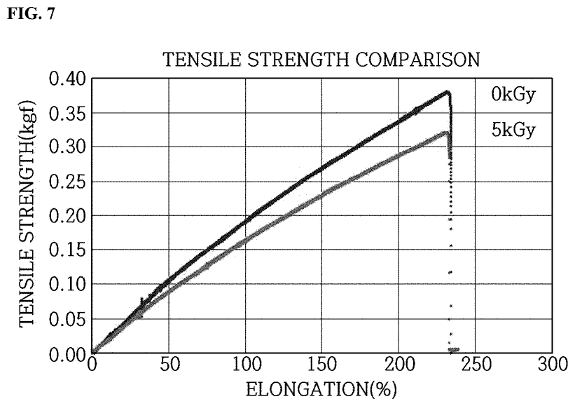

In addition, tensile strength was tested on the natural polysaccharide hydrogel samples of Example 1 and Comparative Example 1, and the results are presented in FIG. 7.

Investigating the tensile strength test results illustrated in FIG. 7, it can be seen that compared to Comparative Example 1, where the crosslinking structure is dense due to no irradiation with electron beams, and Example 1, where the crosslinking structure is somewhat loosely controlled by irradiation with an electron beam, exhibits the same elongation with tensile strength of approximately 90%, and it can be confirmed that the sample with the crosslinking structure controlled by electron beam also maintains sufficient physical strength.

Accordingly, the present invention may prepare a hydrogel composed of two or more kinds of only natural polysaccharides, and particularly, provide a natural polysaccharide hydrogel that may increase functionality, such as a moisturizing effect, while maintaining sufficient physical strength, and may utilize excellent functionality, such as biocompatibility and biodegradability, by controlling the crosslinking structure by using a chain scission reaction through high-energy electron beam irradiation, and in particular, the present invention has an advantage in that since the mesh size is adjustable, moisture or active substances contained in the natural polysaccharide hydrogel are allowed to escape to the outside and be well delivered to the desired area.

The exemplary embodiments described above are merely illustrative of exemplary embodiments of the present invention and the present invention is not limited to the exemplary embodiments, and it will be understood that various modifications, variations, or substitutions of operations may be made by those skilled in the art within the technical ideas and claims of the present invention.

What is claimed is:

1. A hydrogel preparation method using crosslinking structure control by electron beam irradiation, the hydrogel preparation method comprising:
(A) mixing two or more natural polysaccharides and a solvent at room temperature to prepare a preliminary hydrogel composition;
(B) heating the preliminary hydrogel composition to a predetermined temperature or higher to cause the preliminary hydrogel composition to be loosened linearly with respect to a chain-coil structure of the natural polysaccharides, resulting in uniform mixing;
(C) lowering the temperature of the preliminary hydrogel composition to room temperature to gel the preliminary hydrogel composition into a hydrogel, and allowing the two or more natural polysaccharides to form a mesh structure by chain entanglement to form an Interpenetrating Polymer Network (IPN) structure; and
(D) selectively irradiating the hydrogel with a high-energy electron beam to control a crosslinking structure by using chain scission reaction in the IPN structure of the hydrogel.

2. The hydrogel preparation method of claim 1, wherein the natural polysaccharides are two or more kinds selected from alginate, chitosan, carrageenan, agar, guar gum, xanthan gum, gellan gum, and locust bean gum, and
at least one of the two or more kinds includes locust bean gum or carrageenan.

3. The hydrogel preparation method of claim 1, wherein the natural polysaccharide is used at a content of 1 to 10 parts by weight with respect to 100 parts by weight of the solvent used.

4. The hydrogel preparation method of claim 1, wherein the solvent is distilled water.

5. The hydrogel preparation method of claim 1, wherein in the operation (B), the preliminary hydrogel composition is heated to 60° C. to 90° C.

6. The hydrogel preparation method of claim 1, wherein in the operation (D), the electron beam is emitted with energy of 1 MeV to 10 MeV and a radiation dose of 5 kGy to 10 kGy.

7. The method of claim 6, wherein in the operation (D), an electron beam generated from an electron beam accelerator or radioisotope gamma rays is emitted.

8. The hydrogel preparation method of claim 1, wherein in the operation (D), the scission reaction of chain bonding of the natural polysaccharides is controlled by electron beam irradiation to adjust a mesh size within the IPN structure and maintain interconnectivity between the meshes, to complete a hydrogel with the adjusted mesh size.

9. The hydrogel preparation method of claim 1, wherein in the operations (C) and (D), a mold or a container having a predetermined shape is used to shape the hydrogel.

10. A natural polysaccharide hydrogel prepared by the hydrogel preparation method of claim 1.

11. A natural polysaccharide hydrogel prepared by the hydrogel preparation method of claim 2.

12. A natural polysaccharide hydrogel prepared by the hydrogel preparation method of claim 3.

13. A natural polysaccharide hydrogel prepared by the hydrogel preparation method of claim 4.

14. A natural polysaccharide hydrogel prepared by the hydrogel preparation method of claim 5.

15. A natural polysaccharide hydrogel prepared by the hydrogel preparation method of claim 6.

16. A natural polysaccharide hydrogel prepared by the hydrogel preparation method of claim 7.

17. A natural polysaccharide hydrogel prepared by the hydrogel preparation method of claim 8.

18. A natural polysaccharide hydrogel prepared by the hydrogel preparation method of claim 9.
